(19) United States
(12) Patent Application Publication
(10) Pub. No.: US 2026/0131582 A1
(43) Pub. Date: May 14, 2026

(54) RECORDING DEVICE

(71) Applicant: CANON KABUSHIKI KAISHA, Tokyo (JP)

(72) Inventor: TERUYUKI YOSHIDA, Kanagawa (JP)

(21) Appl. No.: 19/348,023

(22) Filed: Oct. 2, 2025

(30) Foreign Application Priority Data
Nov. 11, 2024 (JP) 2024-196495

(51) Int. Cl. B41J 15/04; B41J 11/00; B41J 15/16

(52) U.S. Cl. CPC B41J 15/04; B41J 11/0035; B41J 11/008; B41J 11/0095; B41J 15/16

(57) ABSTRACT

There is used a recording device that including a holding unit of a roll sheet, a conveyance unit that conveys a recording medium from the roll sheet, a recording unit of an image, a detection unit of a splice in the recording medium, and a control unit that controls such that recording on the recording medium conveyed at a predetermined conveyance speed, in which a first conveyance speed and a second conveyance speed faster than the first conveyance speed are set as the predetermined conveyance speed, and in a case where the detection unit detects the splice, the control unit sets a start position where acceleration of the splice for conveying the recording medium at the predetermined conveyance speed is started to be closer to the holding unit in the case of the second conveyance speed than in the case of the first conveyance speed.

### BACKGROUND

### Field of the Technology

The present disclosure relates to a recording device.

### Description of the Related Art

There is known a printing device in which a long continuous recording medium such as roll paper is set, one end thereof is drawn out, printing is performed on a surface while being conveyed by a conveyance roller or the like, and then winding is performed. When the roll paper is replaced during use of such a printing device, two roll papers may be joined by using a dedicated tape.

However, in a case where the roll paper has a joint portion (hereinafter, also referred to as a splice), a problem may occur during printing. A first problem is that a print head rubs against the splice. A second problem is that since the splice has characteristics different from those of a normal recording medium, ink is not normally applied, and a failure such as blurring may occur in a print image. A third problem is that since the splice has a larger thickness than that other portion, tension of the roll paper is finely changed when the splice abuts on the conveyance roller, and noise is added to a conveyance speed of the paper.

Therefore, Japanese Patent Laid-Open No. 2002-046260 discloses a method for setting the front and rear of the splice as a print prohibited region.

However, in the technology of Japanese Patent Laid-Open No. 2002-046260, only the print prohibited region is simply set. Thus, for example, even in a case where the conveyance speed is different for each print mode, conveyance control is uniformly performed, and waste paper may increase.

### SUMMARY

The present disclosure has been made to solve the above problems, and the present disclosure is directed to reduce waste paper when printing is performed on a recording medium having a splice.

The present disclosure provides a recording device comprising:
a holding unit configured to hold a roll sheet in which a recording medium is wound in a roll shape;
a conveyance unit configured to convey the recording medium unwound from the roll sheet held by the holding unit;
a recording unit configured to record an image on the recording medium conveyed by the conveyance unit;
a detection unit configured to detect a splice present on the recording medium; and
a control unit configured to execute control such that the recording unit performs recording on the recording medium conveyed by the conveyance unit so as to have a predetermined conveyance speed,
wherein a first conveyance speed and a second conveyance speed faster than the first conveyance speed are set as the predetermined conveyance speed, and
in a case where the detection unit detects that the splice is present on the recording medium being conveyed, the control unit executes control to convey the splice such that a start position for accelerating the splice to convey the recording medium at the predetermined conveyance speed is closer to the holding unit in the case of the second conveyance speed than in the case of the first conveyance speed.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating a configuration example of a printing device;

FIG. 2 is a diagram illustrating a configuration example of a system;

FIGS. 3A and 3B are diagrams illustrating a configuration example in which a splice tape is detected;

FIG. 4 is a diagram illustrating a configuration example of a UI displayed on the printing device;

FIG. 5 is a diagram illustrating a flowchart of a first embodiment;

FIG. 6 is a diagram illustrating a relationship between a printing speed and a blank paper conveyance distance;

FIG. 7 is a diagram illustrating a positional relationship between the printing speed and after blank paper conveyance;

FIGS. 8A and 8B are diagrams illustrating UIs of a second embodiment;

FIG. 9 is a diagram illustrating a flowchart of the second embodiment;

FIG. 10 is a diagram illustrating a UI of a third embodiment; and

FIG. 11 is a diagram illustrating a flowchart of the third embodiment.

### DESCRIPTION OF THE EMBODIMENTS

Hereinafter, embodiments of the present disclosure will be described in detail with reference to the drawings. However, the dimensions, materials, shapes, relative arrangements, and the like of the components described in the following embodiments should be appropriately changed according to the configuration of the apparatus to which the present disclosure is applied and various conditions. Therefore, the scope of the present disclosure is not limited unless otherwise specified. Although a plurality of features are described in the embodiments, all of the plurality of features are not necessarily essential to the disclosure, and the plurality of features may be arbitrarily combined.

### Embodiment

### Printing Device

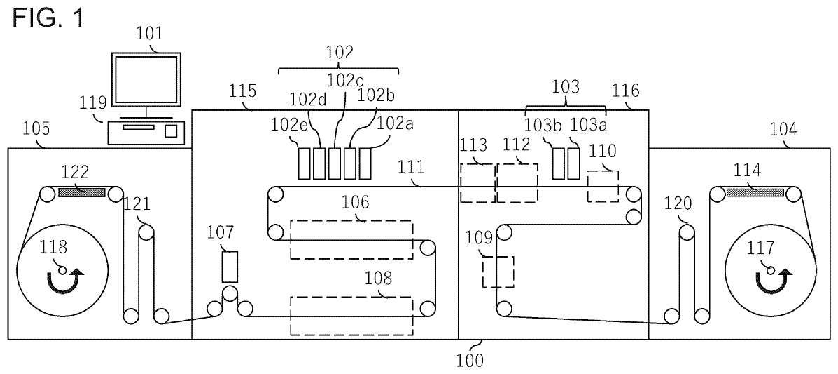

FIG. 1 is a diagram illustrating a configuration example of a printing device (recording device) according to the present embodiment. A printing device 100 forms an image on roll paper 111. The roll paper 111 is continuous paper and is a recording medium capable of continuously forming an image. The printing device 100 includes a paper feeding device 104, a base printing unit 116, an additional printing unit 115, a winding device 105, a UI operation panel 101, and a control PC 119.

The base printing unit 116 performs special color printing as pre-printing. In the special color printing, for example, a base of a predetermined pattern is printed. The additional printing unit 115 performs basic color printing as additional printing. In the basic color printing, for example, printing of a predetermined pattern or the like is performed. That is, the printing device 100 is a digital printing machine that performs pre-printing and additional printing. The base printing unit 116 and the additional printing unit 115 are recording units that record images on a recording medium unwound from a roll sheet (roll paper).

The paper feeding device 104 is a device that supplies the roll paper 111 to the printing device 100. The paper feeding device 104 is a holding unit that holds the roll sheet on which the recording medium is rolled. The paper feeding device 104 rotates a paperboard core of the roll paper 111 around a rotation shaft 117 to unwind the roll paper wound around the paperboard core, and conveys the roll paper 111 toward the printing device 100 at a constant speed via a plurality of rollers (a conveyance roller, a paper feeding roller, and the like). A first dancer unit 120 is a unit for applying tension to the unwound roll paper 111.

The winding device 105 is a device that discharges the roll paper 111 from the printing device 100. The winding device 105 is a device that rotates the roll paper 111 conveyed from the printing device 100 around a rotation shaft 118 at a constant speed via a plurality of rollers (for example, a conveyance roller and a winding roller) to wind the roll paper 111 in a roll shape as a product of the roll paper. In the winding device 105, the roll paper 111 is wound around the paperboard core of the rotation shaft 118 and held in the roll shape. A second dancer unit 121 is a unit for applying tension to the roll paper 111 to be wound.

The paper feeding device 104 includes a workbench 114, and the winding device 105 includes a workbench 122. The workbench 114 and the workbench 122 are tables on which a user mainly performs a work of cutting the roll paper 111 and a work of connecting the roll paper 111.

Before the start of printing, the roll paper 111 is passed from the paper feeding device 104 to the winding device 105 via a predetermined position in the printing device 100. Specifically, the roll paper 111 is first attached to the paper feeding device 104. An end portion of the roll paper 111 attached to the paper feeding device 104 is passed above the workbench 114, through a splice detection unit 109, through a skew feeding correction device 110, and under a first printing device 103 of the base printing unit 116 in order.

The first printing device 103 includes a print head of a special color (for example, a white ink or the like) other than CMYK which are basic colors in printing, and performs printing using the special color on the roll paper 111. In the present embodiment, a print head 103a is a print head of a fixing primer ink, and a print head 103b is a print head of a white ink. The print head prints a character, an image, a base, or the like on paper or the like. A large number of nozzles are provided in each print head, and an image is printed by ejecting ink from the nozzles onto the roll paper 111. The first printing device 103 prints, for example, a base of a predetermined pattern in white.

The roll paper 111 is further passed through a drying device 112, through a cooling device 113, and under a second printing device 102 of the additional printing unit 115 in order.

The second printing device 102 is provided downstream of the first printing device 103, has a print head for each of the printing basic colors (CMYK), and prints the printing basic colors (CMYK). In the present embodiment, a print head 102a is a print head of a fixing primer ink, a print head 102b is a print head of a black ink, a print head 102c is a print head of a cyan ink, a print head 102d is a print head of a magenta ink, and a print head 102e is a print head of a yellow ink. Each color print head prints characters, images, and the like on paper and the like. A large number of nozzles are provided in each print head, and an image is printed by ejecting ink from the nozzles onto the roll paper 111. For example, the second printing device 102 prints an image of a predetermined pattern on a base formed by the first printing device 103.

Each of the print heads included in the first printing device 103 and the second printing device 102 is movable in a direction intersecting a conveyance path. That is, each print head can be displaced to a printing position at the time of printing on the roll paper 111 and a position retracted from the printing position. For example, in a case where the print head can move up and down, the print head is displaced by being raised from the printing position. For example, the print head can be displaced from the printing position when a splice passes a recording position.

The roll paper 111 is further passed through a drying device 106, through a cooling device 108, under a connection scanner device 107, and above the workbench 122 in order. Finally, the roll paper 111 is wound around the rotation shaft 118 of the winding device 105.

When printing is performed, the user inputs a print job (recording job) to the control PC 119 of the printing device 100 after passing in the roll paper 111 in the printing device 100. After the print job is input, the user presses a print start button on the UI operation panel 101 to start printing.

### System Configuration

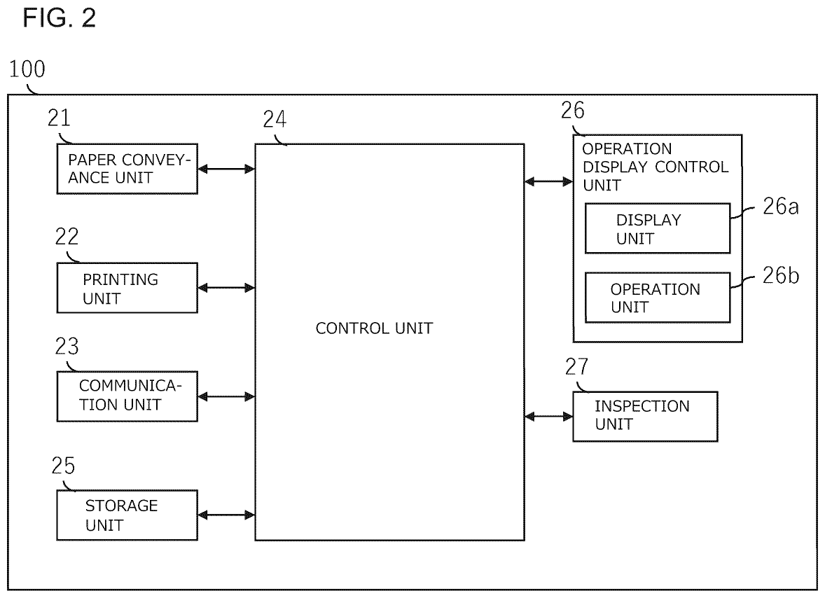

FIG. 2 is a diagram for explaining a system configuration of the printing device 100. The printing device 100 includes a paper conveyance unit 21, a printing unit 22, a communication unit 23, a control unit 24, a storage unit 25, an operation display control unit 26, and an inspection unit 27.

The paper conveyance unit 21 (conveyance unit) controls the paper feeding device 104 and the winding device 105 and performs conveyance control of the roll paper 111 inside the printing device 100. The paper conveyance unit 21 performs control such that the roll paper 111 conveyed from the paper feeding device 104 is conveyed to the base printing unit 116 and the additional printing unit 115 by a plurality of rollers, for example. The paper conveyance unit 21 performs control such that the roll paper 111 having passed through the base printing unit 116 and the additional printing unit 115 is conveyed to the winding device 105 by a plurality of rollers. The paper conveyance unit 21 controls, for example, a conveyance roller group, the first dancer unit 120, the second dancer unit 121, and the like.

The printing unit 22 controls printing operations of the second printing device 102 and the first printing device 103 present in the additional printing unit 115 and the base printing unit 116 on the basis of the received print data. The printing unit 22 determines a timing of ejecting the ink from each nozzle in the print heads of the second printing device 102 and the first printing device 103 onto the roll paper 111, and prints a predetermined image with the ejected ink.

The communication unit 23 includes, for example, a communication control card such as a local area network (LAN) card. The communication unit 23 performs transmission and reception of various kinds of data to and from an external device (for example, a print job input PC) connected to a communication network such as a LAN or a wide area network (WAN).

The control unit 24 is provided inside the control PC 119, and includes, for example, a central processing unit (CPU), a random access memory (RAM), and the like. The CPU of the control unit 24 reads various programs such as a system program and a processing program stored in the storage unit 25, loads the programs into the RAM, and executes various kinds of processing according to the loaded programs. For example, the control unit 24 can perform image forming processing of executing an image forming job (hereinafter, simply referred to as a job) in accordance with an instruction of the user.

The storage unit 25 is provided inside the control PC 119, and includes, for example, a nonvolatile semiconductor memory (so-called flash memory), a hard disk drive (HDD), or the like. The storage unit 25 stores various programs including a system program and a processing program executed by the control unit 24, and various kinds of data necessary for executing these programs.

The operation display control unit 26 includes, for example, a liquid crystal display (LCD) with a touch panel, and includes a display unit 26a and an operation unit 26b. The display unit 26a displays various kinds of information on a display screen on the UI operation panel 101 according to a display control signal input from the control unit 24. The operation unit 26b receives various input operations by the user via various operation keys such as buttons displayed on the UI operation panel 101, and outputs operation signals to the control unit 24. The operation display control unit 26 is used, for example, to set job information when a job is executed. The user can voluntarily set conditions such as paper to be used.

The inspection unit 27 performs confirmation control of a printing state of the printing device. An inspection method may be various methods such as a method for printing and reading an inspection pattern and a confirmation pattern with a scanner, a method for directly reading and inspecting a print image with a camera or a scanner, and a method for monitoring an ejection status from a nozzle. In addition to the print image, confirmation of whether or not a splice tape is attached to the roll paper 111 fed by the splice detection unit 109 is performed. Not only the splice tape but also a failure state of the fed roll paper 111 may be detected.

### Printing Operation

An operation in a case where image forming processing is performed on the roll paper 111 in the printing device 100 will be described. First, the user creates base data and additional printing data of a job in an external device, performs print setting of the job, and transmits these pieces of information to the printing device 100 via a communication network. The control unit 24 of the printing device 100 receives data of the job and print setting information of the job transmitted from the external device via the communication unit 23.

The control unit 24 starts the printing operations on the basis of the received information. That is, the conveyance of the roll paper 111 is started via the paper conveyance unit 21 and the control unit 24, and the second printing device 102 and the first printing device 103 are caused to perform the printing operations on the basis of the print data via the printing unit 22 and the control unit 24.

The inspection unit 27 confirms whether or not printing can be performed on the roll paper 111 without a color registration error. At the time of inspection, first, a pattern for the printing unit 22 to detect the color registration error is printed on the roll paper 111. The inspection unit 27 confirms whether or not the color registration error occurs by analyzing a scan image obtained by reading the printed detection pattern by the connection scanner device 107. The inspection unit 27 can also confirm whether or not there is an ejection failure by using a pattern for detecting the ejection failure of the print head. The inspection unit 27 can confirm whether or not there is color unevenness by using a pattern for detecting the color unevenness. The inspection unit 27 can also confirm a color tone by using a pattern for detecting the color tone. In addition to the above description, the inspection unit 27 can confirm an inspection item by using a pattern corresponding to the inspection item.

### Splice Detection

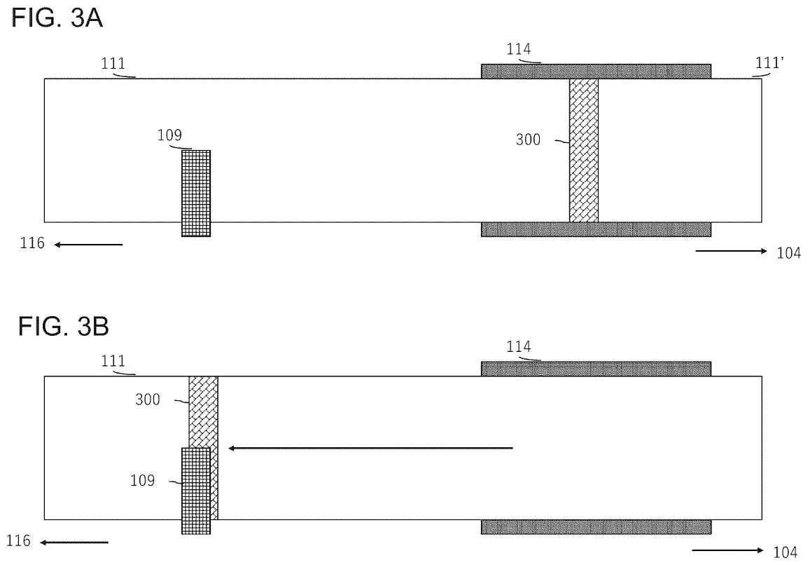

The movement at the time of splice detection will be described with reference to FIGS. 3A and 3B. In the drawing, a left side is a direction of the base printing unit 116, and a right side is a direction of the paper feeding device 104. Members that are not related to the description of the conveyance roller and the like are omitted. A direction change of the roll paper 111 is omitted. FIG. 3A illustrates a state where the roll paper 111 remaining in the printing device 100 and a replaced roll paper 111′ are connected by the splice 300 after the roll paper in the paper feeding device 104 is replaced. A connection operation is performed on the workbench 114.

After the joining is completed, when the roll paper 111 (a connected roll paper of the roll paper 111 and the roll paper 111′) is conveyed, the splice 300 moves to a position of the splice detection unit 109, and the state in FIG. 3B is obtained. The splice detection unit 109 is a detection unit that discovers the splice. In a case where an ultrasonic sensor is used as the sensor, the splice detection unit 109 detects that a thickness of the roll paper 111 changes by a thickness of the splice 300. In a case where the splice detection unit 109 uses a color sensor, a difference in surface color between the roll paper 111 and the splice 300 is detected. However, a type and a detection method of the sensor are not limited thereto.

### UI: User Interface

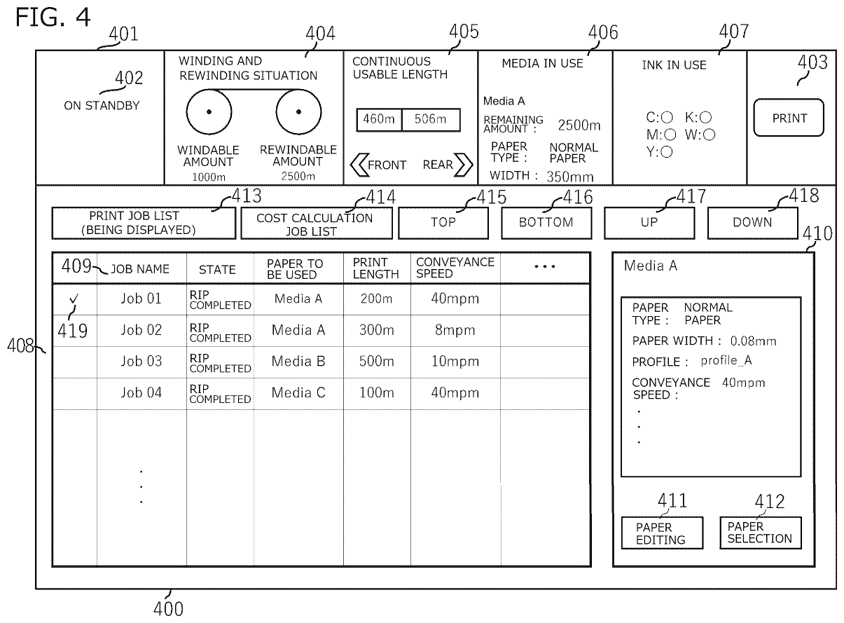

FIG. 4 is an example of a UI screen on which a list of print jobs is displayed in the present embodiment. In FIG. 4, a UI screen 400 is a UI displayed on the UI operation panel 101. The UI screen 400 may be displayed on the entire display, or the UI screen 400 may be displayed as a window in the display.

In a status display area 401, summary information regarding a state of the printing device 100 such as a current state of the printing device 100 or information of a job being printed is displayed.

An operation status display 402 of the printing device 100 indicates a status of the printing device 100. In FIG. 4, printing is “on standby”. In addition to “on standby”, an operation status includes “stopped”, “during printing”, and the like. The user can display a pop-up of a print confirmation screen by pressing a print button 403. When the user presses an OK button in the pop-up, the selected print job is started.

In an unwinding and winding status display 404, an unwindable amount and a windable amount of the roll paper 111 are displayed. In a continuous usable length display 405, a continuous printable length of the roll paper 111 attached to the printing device 100 is displayed. A print medium information display 406 displays a name and a remaining amount of the roll paper 111 attached to the printing device 100. An ink state display 407 displays a type of ink being used or a state of the remaining amount.

In the present embodiment, an example in which contents of the status display area 401 are an operation status display, a print button, a printing job display, a print medium information display, an ink state display, and a continuous usable length of the printing device 100 is illustrated. However, the display contents are not limited thereto.

A work area 408 is an area for the user to perform an operation. In a case where detailed information related to each piece of information in the status display area 401 is confirmed, each state display region of the status display area 401 is pressed to display the related detailed information in the work area 408.

A print job list 409 displays information such as an ID, a current state, a print medium, a print length, and a conveyance speed of the print job. The print button 403 is pressed for the job selected in this list, and thus, the printing device 100 starts printing.

A print medium information display 410 displays detailed information of the print medium. A paper edit button 411 can edit information of the print medium displayed in the print medium information display 410. A paper selection button 412 is used in a case where new paper information that is not currently set paper information is read. Settings read by the paper selection button 412 are displayed in the print medium information display 406, as the information of the print medium attached to the printing device 100.

A cost calculation job list is displayed in the work area 408 by pressing a cost calculation job list button 414 while the print job list 409 is being displayed. On the other hand, a print job list button 413 is pressed while the cost calculation job list is being displayed, and thus, the print job list 409 and the operation buttons of the print job are displayed in the work area 408.

In the present embodiment, in a state where the print job list is displayed, a plurality of buttons for operating a print order of the print jobs is displayed. That is, a TOP button 415 for placing the selected job at the top of the print job list, a BOTTOM button 416 for placing the selected job at the bottom of the print job list, an UP button 417 for moving up the order of the selected job by one, and a DOWN button 418 for moving down the order of the selected job by one. A print selection check 419 is displayed when a job to be printed is selected.

Jobs of Job01 to Job04 are displayed in the print job list 409 of FIG. 4. Three types of MediaA, MediaB, and MediaC are displayed as a type of paper to be used. In a case where it is desired to print Job02 after Job01, since any paper to be used is MediaA, it is not necessary to replace the roll paper on the paper feed side. In this case, printing may be continuously performed without stopping the printing operations of Job01 and Job02, or the device may be stopped once after the printing of Job01, and Job02 may be printed after an interval.

In a case where it is desired to print Job03 after Job02, since the paper to be used is changed from MediaA to MediaB, it is necessary to replace the roll paper on the paper feed side. Thus, after Job02 is printed, the paper conveyance unit 21 stops the conveyance of the roll paper 111. The user performs a work of replacing the roll paper 111 of the paper feeding device 104. When the replacement work of the roll paper 111 is performed, it is necessary to connect the replaced roll paper 111′ with the roll paper 111 remaining in the printing device 100 by the splice 300. Thus, after the replacement of the roll paper, as illustrated in FIG. 3A, the roll paper 111 and the roll paper 111′ are connected by the splice 300. Thereafter, when Job03 is started, the splice 300 reaches the splice detection unit 109 while the joined roll paper (the connected roll paper of the roll paper 111 and the roll paper 111′) is being conveyed, and the state of FIG. 3B is obtained.

### First Embodiment

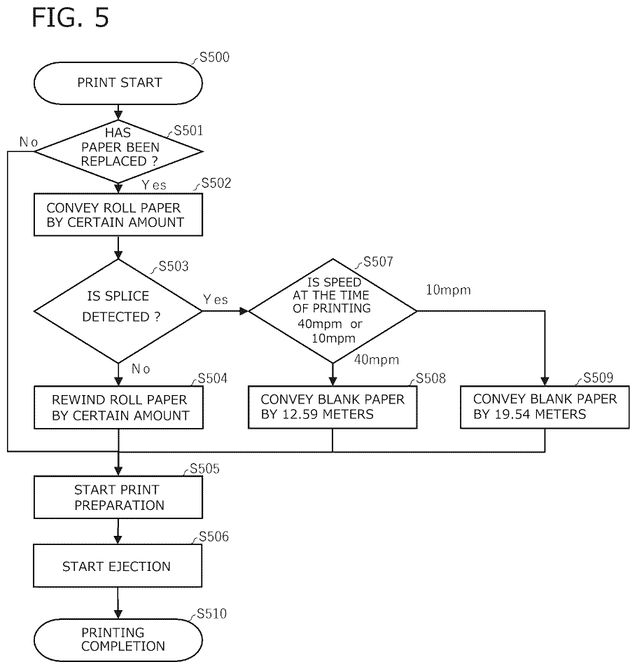

A first embodiment using the printing device 100 described above will be described. FIG. 5 is a flowchart of the present embodiment, and each step is executed by the control unit 24 controlling each component in the printing device. In step S500, printing is started.

In step S501, the control unit 24 determines whether or not the roll paper 111 is replaced at the start of printing in step S500. For example, the paper conveyance unit 21 detects that tension decreases in the first dancer unit 120 being controlled, and the control unit 24 receives information thereof. As a result, it can be determined that the roll paper 111 is replaced. For example, in a case where Job02 is printed after the printing of Job01, the paper replacement is not performed (S501=No). In this case, the processing proceeds to step S505 to perform print preparation.

In the print preparation in step S505, the print heads 102a to 102e and 103a to 103b are moved to the printing positions in accordance with an instruction of the printing unit 22. The control unit 24 raises or lowers temperatures of the drying devices 106 and 112 and the cooling devices 108 and 113 to predetermined temperatures. The conveyance of the roll paper 111 is started in accordance with an instruction from the paper conveyance unit 21, and the roll paper is conveyed while being accelerated to be 10 mpm.

When the print preparation is completed, the ejection of the ink from the print head is started in step S506. When all pages of the print job are printed, the printing is completed in step S510.

On the other hand, for example, in a case where Job03 is printed after the printing of Job02, since the paper to be used is changed from MediaA to MediaB, it is necessary to replace the roll paper on the paper feed side. In a case where printing is started after the roll paper 111 is replaced (S501=Yes), the processing proceeds to step S502, and the roll paper 111 is conveyed by a certain amount in accordance with an instruction of the paper conveyance unit 21. The certain amount is a conveyance amount until a portion of the roll paper 111 positioned on the workbench 114 reaches the position of the splice detection unit 109. A conveyance stop timing may be when the splice is immediately below the splice detection unit 109, or may be after the splice slightly passes the splice detection unit 109.

In step S503, the inspection unit 27 determines whether or not the splice detection unit 109 detects the splice 300 at the time of conveyance. In a case where the splice is detected (S503=Yes), the control unit 24 acquires conveyance speed information in the setting information at the time of printing from the storage unit 25. In this example, since a conveyance speed of the job of Job03 is 10 mpm (meters per minute), 10 mpm is acquired as the conveyance speed information. In step S507, the control unit 24 determines whether the acquired conveyance speed is 40 mpm or 10 mpm. As for Job03 in this example, the processing proceeds to step S509.

In step S509, the paper conveyance unit 21 conveys the roll paper by 19.54 m, and then stops once. The processing proceeds to step S505 to perform print preparation. In the print preparation, the control unit 24 moves the print head at the retracted position to the printing position according to the detection of the splice. The control unit 24 raises the temperatures of the drying devices 106 and 112. When the print preparation is completed, the processing proceeds to step S506, and the ejection of the ink from the print head is started. Thereafter, in step S510, the processing ends when all the pages of the print job are printed.

On the other hand, in a case where the conveyance speed is 40 mpm as in Job04 in the determination in step S507, the processing proceeds to step S508. In step S508, the paper conveyance unit 21 conveys the roll paper by 12.59 m, and then stops once. The subsequent processing of S505 to S510 is similar to the case of step S509.

For example, when it is desired to print Job02 after Job01, the user starts the roll paper replacement work, but there is a possibility that the user interrupts the work while realizing that the replacement is not necessary. In this case, in step S501, a decrease in tension of the first dancer unit 120 is detected, and it is determined that the paper replacement is performed. However, since there is no splice, the splice 300 is not detected in step S503. Therefore, the processing proceeds to step S504, and the roll paper 111 is rewound by a length of the roll paper conveyed in S502. The subsequent processing of S505 to S510 is similar to the case of step S509.

A speed at which the roll paper is conveyed in steps S508 and S509 is a fixed speed regardless of the conveyance speed at the time of printing. Here, the speed is set to 10 mpm.

In this flow, 12.59 m and 19.54 m of conveyance are performed in steps S508 and S509, respectively. A method for calculating a conveyance distance will be described. The conveyance distance can be set such that the splice 300 just reaches the winding device 105 when the acceleration conveyance of the roll paper in the print preparation is ended. That is, the conveyance distance is selected such that the splice is positioned in front of the winding device 105.

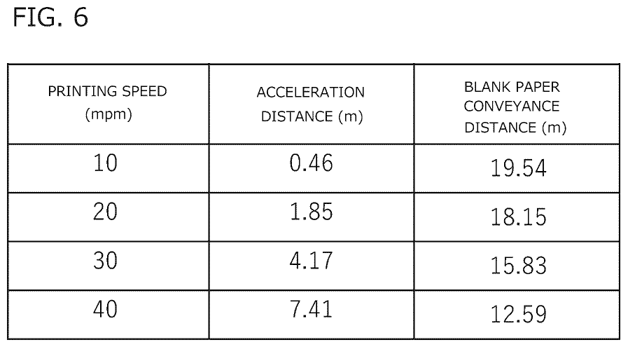

As an example, FIG. 6 illustrates a relationship between a printing speed (mpm) when an acceleration a is 0.03 (m/s\hat{ }2) and the conveyance distance to the splice detection unit 109 and the winding device 105 is 20 m, a distance required for acceleration (acceleration distance (m)), and a blank paper conveyance distance (m).

A calculation method in the case of 10 mpm of the printing speeds illustrated in FIG. 6 is illustrated below. First, a speed v is converted from mpm to m/s\hat{ }2 by the following Expression (1).

$$[ Math . 1 ]$$

$$v = 10 \div 60 ≅ 0.166667 \qquad ( 1 )$$

A time t until reaching 10 mpm is obtained from the acceleration a and the speed v by the following Expression (2).

$$[ Math . 2 ]$$

$$t = \frac{v}{α} = 0.166 \; 667 \div 0.03 ≅ 5.56 \qquad ( 2 )$$

A distance x moved for 5.56 seconds is obtained as 0.46 m by the following Expression (3).

$$[ Math . 3 ]$$

$$x = \frac{1}{2} α {t}^{2} = \frac{1}{2} \times 0.03 \times 5.5 {6}^{2} ≅ 0.46 \qquad ( 3 )$$

Since the conveyance distance to the splice detection unit 109 and the winding device 105 is 20 m, the blank paper conveyance distance is obtained as 19.54 m by subtracting 0.46 m from 20 m.

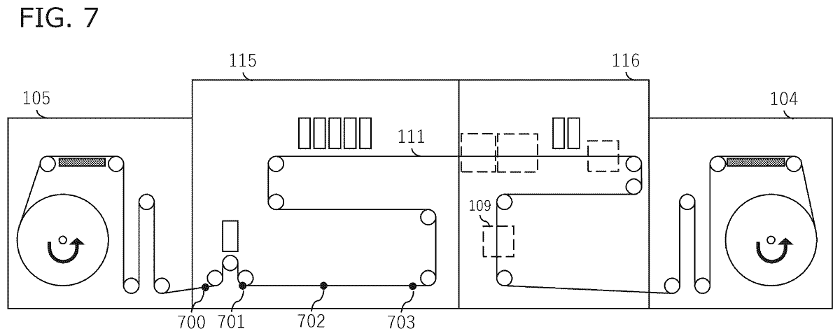

A relationship between four printing speeds of 10 mpm, 20 mpm, 30 mpm, and 40 mpm in FIG. 6 and a position after the blank paper conveyance will be described in FIG. 7. A position 700 is a position after the blank paper conveyance at 10 mpm. When the conveyance speed is 10 mpm, since the distance required for acceleration is the smallest, the paper is conveyed to the position 700 close to the winding device 105. A position 701 is a position after the blank paper conveyance when the conveyance speed is 20 mpm, a position 702 is a position after the blank paper conveyance when the conveyance speed is 30 mpm, and a position 703 is a position after the blank paper conveyance when the conveyance speed is 40 mpm. When the conveyance speed is 40 mpm, since the distance required for acceleration is the largest, the paper is conveyed to the position 703 farthest from the winding device 105.

It is desirable to start an acceleration when the splice is on a downstream side of the print head 102 in a conveyance direction such that the splice does not collide with the print head 102. However, in a case where the acceleration is started with the splice on an upstream side of the print head 102, the print head is moved to the printing position after the splice passes through the second printing device 102.

The acceleration distance may be determined by adding a time until the conveyance speed is stabilized. Considering a time until stabilization, the acceleration distances in FIG. 6 become longer. In this case, the acceleration distance may be determined by multiplying each value by a certain coefficient, or may be determined by adding a predetermined value to each value.

In the above description, the winding device 105 is calculated as an end point, but the other position may be calculated as the end point. In a case where the roll paper 111 is conveyed during the print preparation for a reason other than the acceleration conveyance, a distance for the blank paper conveyance may be determined in consideration of the conveyance distance thereof.

For example, in a case where the conveyance speed is 10 mpm, the blank paper conveyance distance refers to a distance from when the splice detection unit 109 detects the splice 300 to when the detected portion is conveyed to position 700. The blank paper conveyance distance will be described by illustrating a case where the conveyance speed at the time of printing is 10 mpm. Here, (1) in order to eliminate the influence on the printing by the splice 300, it is preferable that the splice 300 exits the additional printing unit 115 and reaches the inside of the winding device 105 at the start of printing. The position in the winding device is referred to as a retracted position 105a. (2) From the viewpoint of reducing waste paper, a speed of the roll paper 111 preferably reaches 10 mpm at a point in time when the splice 300 reaches the retracted position 105a in the winding device 105 and printing can be started. As will be described later, in the present embodiment, the conveyance speed (corresponding to steps S508 and S509) at the time of blank paper conveyance is constant. Thus, it is necessary for the conveyance unit to accelerate from the conveyance speed (pre-printing conveyance speed or pre-recording conveyance speed) at the time of blank paper conveyance to a predetermined conveyance speed during printing (conveyance speed at the time of printing or conveyance speed at the time of recording) in the distance until the splice 300 reaches the retracted position 105a from the position 700. This distance is referred to as an acceleration conveyance distance. The time required for acceleration and the acceleration conveyance distance become longer as the conveyance speed at the time of printing is faster. Thus, the position 703 where the acceleration is started in a case where the conveyance speed is 40 mpm (an acceleration conveyance start position in the case of 40 mpm) is on the upstream side in the conveyance direction from the position 700 where the acceleration is started in a case where the conveyance speed is 10 mpm (an acceleration conveyance start position in the case of 10 mpm). That is, it is assumed that a first recording job in which the roll paper 111 is conveyed at a first conveyance speed and a second recording job in which the roll paper is conveyed at a second conveyance speed are set, and the second conveyance speed is set to be higher than the first conveyance speed. At this time, the position 703 where the acceleration is started in the second recording job is on the upstream side in the conveyance direction from the position 700 where the acceleration is started in the first recording job. In other words, a start position where the splice to be accelerated is on the upstream side (the holding unit side) in the case of the second conveyance speed rather than the case of the first conveyance speed.

In the printing device in which the user replaces the roll paper 111 to perform splice connection, it is necessary to convey the splice to the winding device side at the start of printing after the replacement. In the related art, since control corresponding to a print mode is not performed at the time of conveyance, there is a concern that the amount of waste paper increases. However, according to the configuration of the present embodiment, since the print prohibited region can be changed in accordance with the print mode, the amount of waste paper can be reduced.

### Modified Example

A derivative configuration in the first embodiment will be described below. First, the method for detecting the paper replacement in step S501 is not limited to the determination from the tension of the first dancer unit 120, and other methods may be used. For example, when the paper replacement is performed, since the remaining amount of paper changes, determination may be performed on the basis of the change amount of the remaining amount of paper calculated by using a weight sensor or the like.

In the above flow, in step S507, an option of the conveyance speed is either 40 mpm or 10 mpm, but the determination may be performed from three or more types of conveyance speeds. In this case, it is not necessary to select three types of conveyance distances for three types of conveyance speeds, and the conveyance distances selected at any two types of conveyance speeds may be the same. For example, in a case where there are three types of conveyance speeds of 40 mpm, 20 mpm, and 10 mpm, the same values as 12.59 m at 40 mpm and 18.15 m at 20 mpm and 10 mpm may be selected. For example, a branch corresponding to a range of the conveyance speed such as “less than or equal to 20 mpm or greater than 20 mpm” may be provided.

In the above flow, after the blank paper conveyance in steps S508 and S509 is ended, the print preparation is started in step S505, but the print preparation may be started simultaneously with the blank paper conveyance. Although the speed at which the roll paper is conveyed is the fixed value in S508 and S509, the conveyance speed at the time of printing may be used.

### Second Embodiment

Next, a second embodiment will be described. Description of the same configuration and operation as those of the first embodiment will be omitted.

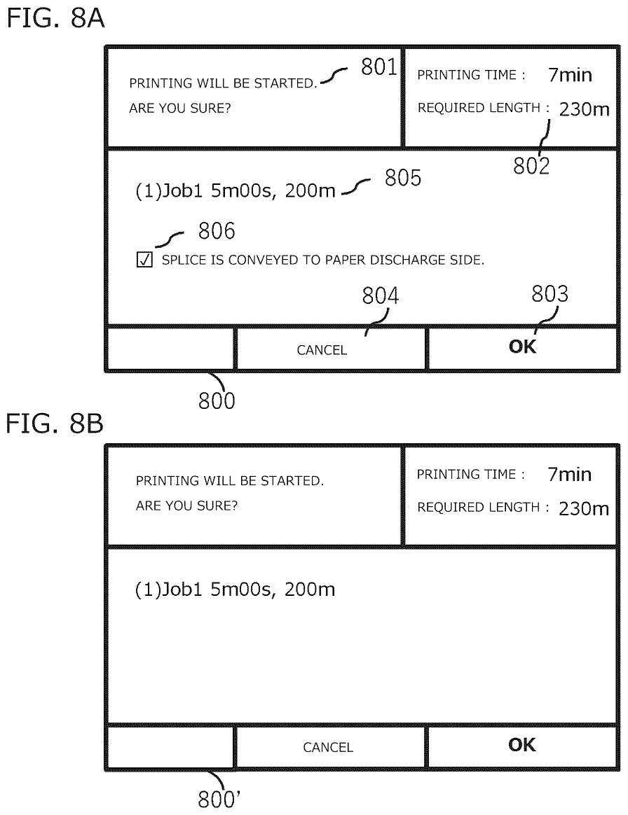

FIGS. 8A and 8B illustrate a UI displayed in the present embodiment. When the user presses the print button 403 (see FIG. 4), a pop-up 800 for confirming print contents is displayed as illustrated in FIG. 8A. A message display area 801 displays a confirmation message for starting printing. An area 802 that displays a time and a length displays a length of the roll paper 111 required for printing and a print time. An OK button 803 is pressed, and thus, printing is started. Thereafter the pop-up is closed. When a cancel button 804 is pressed, the pop-up is closed without starting printing. A print content display area 805 displays a print length and the print time of each selected job. A print setting selection display 806 may be displayed in the print content display area 805. In FIG. 8A, a check box for selecting whether or not to convey the splice to the winding side is displayed.

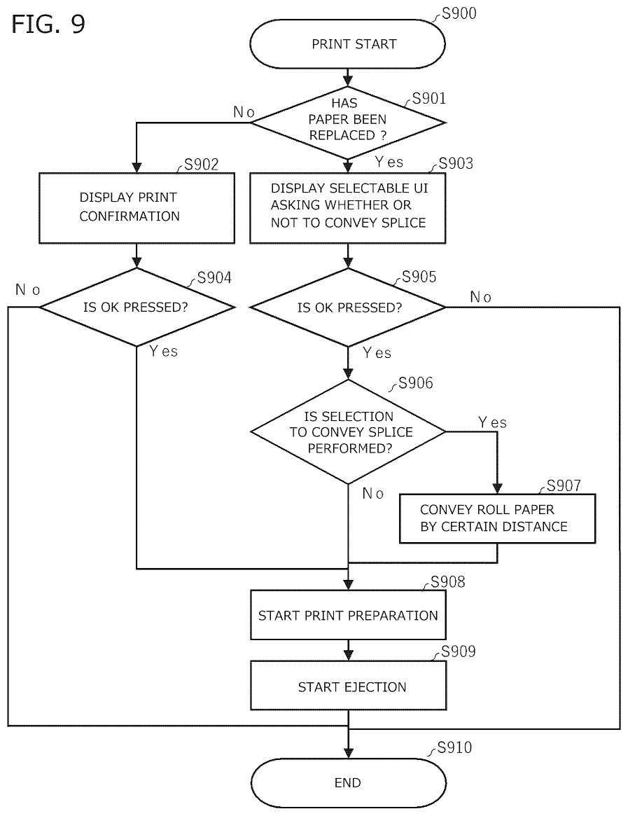

A sequence of the second embodiment will be described in FIG. 9. In step S900, printing is started. In step S901, the control unit 24 determines whether or not the paper replacement is performed. The determination method is similar to that of the first embodiment. In a case where the paper is not replaced (S901=No), the operation display control unit 26 performs a print confirmation display on the display unit 26a. Since there is no need to perform a display related to the splice in a case where the paper replacement is not performed, a pop-up 800′ without the print setting selection display 806 is displayed as illustrated in FIG. 8B.

Thereafter, in step S904, the control unit 24 determines whether or not the user presses the OK button 803. In a case where the OK button 803 is pressed (S904=Yes), the print preparation is started in step S908, ink ejection from the print head is started in step S909, and when the printing of all pages is completed, the processing proceeds to step S910 and ends. On the other hand, in a case where the user presses the cancel button 804 (S904=No), the processing proceeds to step S910 without performing printing, and ends.

In a case where it is determined in step S901 that the paper replacement is performed, the processing proceeds to step S903, and the operation display control unit 26 displays the pop-up 800 on the display unit 26a. As a result, the user can select whether or not to convey the splice to the winding side by using the print setting selection display 806. In step S905, the control unit 24 determines whether or not the user presses the cancel button 804.

In a case where the user presses the cancel button (S905=No), the processing proceeds to step S910 without performing printing, and ends. On the other hand, in a case where the user presses the OK button 803 (S905=Yes), the processing proceeds to step S906, and the operation display control unit 26 determines whether or not selection to convey the splice to the winding side is performed. In a case where the selection to convey the splice to the winding side is performed (S906=Yes), the operation display control unit 26 notifies the control unit 24 of the selection. The control unit 24 instructs the paper conveyance unit 21 to convey the paper to the winding side. In step S907, the paper conveyance unit 21 conveys the roll paper 111 by a certain distance. Subsequent steps S908 to S910 are similar to those in the above case.

On the other hand, in a case where the selection to convey the splice to the winding side is not performed (S906=No), processing of steps S908 to S910 is directly performed.

In the present embodiment, the user can select whether or not to convey the splice to the winding side, and the splice is conveyed to the winding side only in a case where selection indicating that conveyance is necessary is performed. On the other hand, in a case where the user determines that conveyance is unnecessary, since printing is performed without conveying the splice to the winding side, the amount of waste paper can be reduced.

### Modified Example

A derivative configuration in the second embodiment will be described below. In the above flow, the presence or absence of the paper replacement is detected in step S901, and whether or not to display the print setting selection display 806 is controlled in accordance with the detection result. However, the print setting selection display 806 may be constantly displayed.

In the above flow, in step S907, the roll paper 111 is conveyed by a certain distance. However, as in the first embodiment, the conveyance distance may be changed on the basis of the conveyance speed information at the time of printing. As a result, in a case where the user selects that conveyance is necessary, the amount of waste paper can be reduced.

### Third Embodiment

Next, a third embodiment will be described. The same configurations and operations as those of the first to second embodiments will not be described.

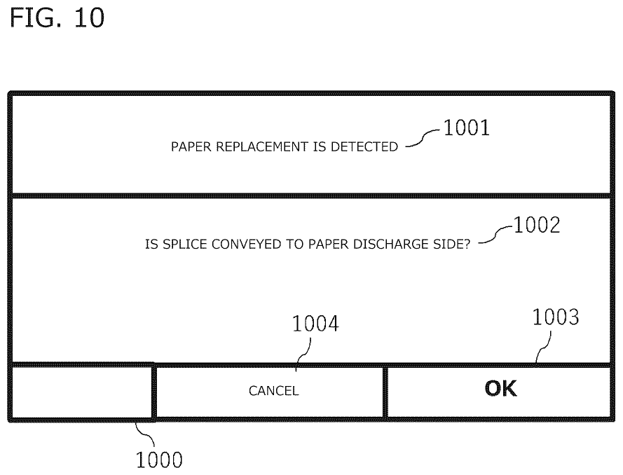

FIG. 10 illustrates a UI displayed in the present embodiment. In the present embodiment, when the control unit 24 detects the paper replacement, a pop-up 1000 for confirming whether or not to send the splice to the winding side is displayed. In a message display area 1001, information indicating that the paper replacement is detected is displayed. In a confirm item display area 1002, a message asking whether or not to convey the splice to the winding side is displayed. An OK button 1003 is a button that is pressed to convey the roll paper 111 to the winding side by a certain distance. After the conveyance, the pop-up 1000 is closed. A cancel button 1004 is a button that is pressed to close the pop-up without conveying the roll paper 111.

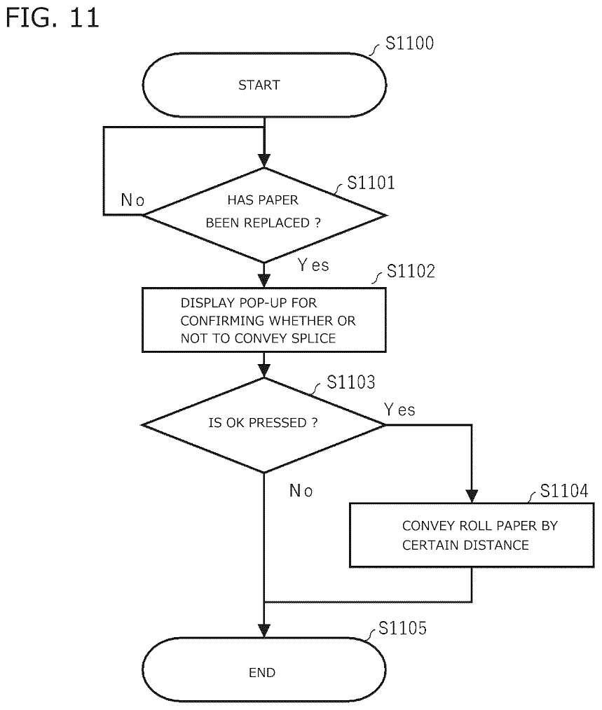

A sequence of the third embodiment is described in FIG. 11. This flow is performed at the time of activating the printing device 100. This flow may be executed in a case where the user operation is performed, or may be executed periodically. After the printing device 100 is activated in step S1100, the paper conveyance unit 21 monitors tension information of the first dancer unit 120. In step S1101, it is determined whether or not the roll paper replacement is performed. For example, when a decrease in the tension of the first dancer unit 120 is detected, the paper conveyance unit 21 determines that the roll paper replacement is performed.

In a case where the paper replacement is performed (S1101=Yes), in step S1102, the operation display control unit 26 displays the pop-up 1000 on the display unit 26a, and the user can select whether or not to perform the paper conveyance. In step S1103, the operation display control unit 26 determines whether or not the user presses the OK button 1003. In a case where the OK button 1003 is pressed (S1103=Yes), the operation display control unit 26 notifies the control unit 24 of the fact that the OK button is pressed. The control unit 24 instructs the paper conveyance unit 21 to convey the roll paper 111. In step S1104, the paper conveyance unit 21 conveys the roll paper 111 by a certain distance. Thereafter, the processing proceeds to step S1105 and ends.

On the other hand, in a case where the user presses the cancel button 1004 in the pop-up 1000 (S1103=No), the processing proceeds to step S1105 without doing anything and ends.

In the present embodiment, the paper replacement can be detected at a timing other than a print job timing, and the user can select whether or not to convey the splice to the winding side.

### Modified Example

A derivative configuration in the third embodiment will be described below. In the above flow, after the conveyance is performed for a certain distance in step S1104, and after the user presses the cancel button 1004 (in the case of S1103=No), the processing proceeds to step S1105 and ends. However, the processing returns to step S1101 and monitoring may be continued.

### OTHER EMBODIMENTS

As another embodiment, a dedicated button for conveying the splice may be provided on the UI of the device, and in a case where the button is pressed, the paper conveyance unit 21 may convey the roll paper 111 toward the winding side for a certain distance.

According to the technology described in the present specification, a paper loss can be reduced. The technology described herein may contribute to the realization of a sustainable society such as a decarbonized and cyclical society.

According to the present disclosure, it is possible to reduce waste paper when printing is performed on a recording medium having a splice.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-196495, filed Nov. 11, 2024, which is hereby incorporated by reference herein in its entirety.

What is claimed is:

1. A recording device comprising:
a holding unit configured to hold a roll sheet in which a recording medium is wound in a roll shape;
a conveyance unit configured to convey the recording medium unwound from the roll sheet held by the holding unit;
a recording unit configured to record an image on the recording medium conveyed by the conveyance unit;
a detection unit configured to detect a splice present on the recording medium; and
a control unit configured to execute control such that the recording unit performs recording on the recording medium conveyed by the conveyance unit so as to have a predetermined conveyance speed,
wherein a first conveyance speed and a second conveyance speed faster than the first conveyance speed are set as the predetermined conveyance speed, and
in a case where the detection unit detects that the splice is present on the recording medium being conveyed, the control unit executes control to convey the splice such that a start position for accelerating the splice to convey the recording medium at the predetermined conveyance speed is closer to the holding unit in the case of the second conveyance speed than in the case of the first conveyance speed.

2. The recording device according to claim 1, wherein the control unit determines a conveyance distance at which the conveyance speed reaches the predetermined conveyance speed when the splice is conveyed to a retracted position based on the predetermined conveyance speed.

3. The recording device according to claim 2, wherein the control unit starts recording of the image after the splice is conveyed to the retracted position.

4. The recording device according to claim 2, further comprising:
a winding unit configured to wind the recording medium on which the image is recorded by the recording unit,
wherein the retracted position is a position included in the winding unit.

5. The recording device according to claim 2, wherein the control unit determines the conveyance distance based on the predetermined conveyance speed and an acceleration.

6. The recording device according to claim 5, wherein the start position of the acceleration of the splice is on a downstream side of the recording unit.

7. The recording device according to claim 1, wherein the recording unit is displaceable so as to be retracted from a conveyance path of the recording medium, and
the control unit displaces the recording unit when the splice passes through a position where the recording by the recording unit is performed.

8. The recording device according to claim 1, wherein the control unit determines whether or not the recording medium of the roll sheet on a side of the holding unit is replaced, and conveys the recording medium by a distance from the holding unit to the detection unit without performing the recording of the image in a case where it is determined that the replacement is performed.

9. The recording device according to claim 8, wherein, when the control unit determines that the recording medium has been replaced and conveys the recording medium without performing recording of the image, the control unit then rewinds and conveys the recording medium when the detection unit does not detect the presence of the splice.

10. The recording device according to claim 1, wherein different conveyance speeds are settable for each recording job.

11. The recording device according to claim 1, wherein different conveyance speeds are settable in accordance with a type of the recording medium.

12. The recording device according to claim 8, wherein, in a case where it is determined that the recording medium of the roll sheet on the side of the holding unit is replaced, the control unit enables a user to select whether or not to convey the recording medium before the recording of the image is started.

13. The recording device according to claim 8, wherein the control unit determines whether or not the recording medium of the roll sheet on the side of the holding unit is replaced based on tension of the recording medium.
